(19) United States
(12) Patent Application Publication
(10) Pub. No.: US 2019/0370923 A1
(43) Pub. Date: Dec. 5, 2019

(54) AUGMENTED REALITY PARKING DEVICES AND METHODS OF USING THE SAME

(71) Applicant: IPS Group Inc., San Diego, CA (US)

(72) Inventors: Chad P. RANDALL, San Diego, CA (US); Mayank PARMAR, San Diego, CA (US)

(21) Appl. No.: 16/431,525

(22) Filed: Jun. 4, 2019

Related U.S. Application Data
(60) Provisional application No. 62/680,056, filed on Jun. 4, 2018.

(51) Int. Cl. G06Q 50/30; G06F 16/22; G06F 3/0481; G06T 11/60

(52) U.S. Cl. CPC G06Q 50/30; G06F 16/22; G06T 2200/24; G06T 11/60; G06F 3/04817

(57) ABSTRACT

Disclosed are augmented reality parking systems as well as methods and platforms for operating augmented reality parking systems.

### CROSS-REFERENCE TO RELATED APPLICATIONS

This application claims the benefit of U.S. Application Ser. No. 62/680,056, filed Jun. 4, 2018, the entire contents of which are hereby incorporated by reference.

### BACKGROUND

In large cities, municipal governments manage metered parking spaces for the public, especially people who need short term parking spaces. Therefore, parking rules and rates are established to encourage parking turnover, allowing more people access to high-demand parking spaces in the cities. In Los Angeles, the municipal government manages about 40,000 on-street and off-street public metered parking spaces; in Washington D.C., about 18,000; and in New York, about 82,000. One report states that the revenue from the Washington D.C.'s parking meters totaled $40 million in 2015. Another report states that the Department of Public Works at Washington D.C., which handles most of issued parking tickets with about 200 parking enforcement officers, hand out 1.54 million tickets in the fiscal year of 2017. However, problems associated with malfunctioned parking meters and parking violations not ticketed, if not corrected, lead to a significant loss of revenue to municipal governments and circumvent parking policies. Drivers also have trouble locating vacant parking spaces in the city even though the vacant parking spaces are only a few blocks away or one level down from a packed parking garage.

### SUMMARY OF THE INVENTION

One objective for the present invention is to solve current parking issues with more real time data, and data presented in a user friendly, data rich, and actionable format. The present invention allows for the parking policies to be efficiently enforced, parkers to efficiently find spaces, thereby aids in the efficient flow of traffic. Accordingly parking customers achieve better efficiency as does the city.

The enforcement of conventional parking meter-based parking relies on the parking enforcement officer checking each parking space and its associated meter or using automated license plate reading system to accomplish the same, and it creates several ways of placard being abused. A valid placard is used by people or vehicles other than those originally intended, such as relatives or friends when the intended party is not present. A counterfeit placard is very easy to pass a fake as the real thing without an easy mechanism to confirm validity. An intended party uses a valid placard for a longer duration than originally intended by the original intended party or anyone else in possession of the placard.

The novel idea disclosed herein is applying electronic and security aspect to a generally paper based placard. It utilizes technology to overcome the many reasons that placards are abused without obstructing the intended and original purpose of issuing such placards and without dramatically changing the form factor or the traditional model. The present invention addresses all of these issues by making it more difficult to create counterfeits, provides visual indication for enforcement and validity purposes, including interaction with 3^{rd} party enforcement device, and is only activated by the person for whom the placard was originally intended.

In one aspect, disclosed herein are computer-implemented methods for generating augmented reality display related to parking, comprising: capturing a live view or a saved image of a real-world comprising at least one parking meter; producing an information layer, the information layer providing information of the at least one parking meter; and overlaying the information layer on the live view or the saved image.

In some embodiments, the method further comprises: providing a control for interacting with the information layer. In some embodiments, the method further comprises: updating the information layer in real-time. In some embodiments, the information is maintenance status, parking violation status, or vacancy status of the at least one parking meter. In some embodiments, the method further comprises: receiving input from a user. In some embodiments, the input from the user allows the method to access to user's profile. In some embodiments, the information of the at least one parking meter is determined based on the user's profile. In some embodiments, the user is a maintenance technician, an enforcement officer, or a driver.

In another aspect, disclosed herein are computing devices within an augmented reality parking system, comprising: a power source; a memory; a camera; a database module configured to access information of at least one parking meter; and a digital content processor configured to: capture a live view or a saved image of a real-world comprising the at least one parking meter; produce an information layer, the information layer providing information of the at least one parking meter, the information retrieved by the database module; and overlay the information layer on the live view or the saved image.

In some embodiments, the digital content processor is configured to provide a control for interacting with the information layer. In some embodiments, the database module and the digital content processor are configured to update the information layer in real-time. In some embodiments, the information is maintenance status, parking violation status, or vacancy status of the at least one parking meter. In some embodiments, the user is a maintenance technician, an enforcement officer, or a driver. In some embodiments, the computer device is a mobile phone, smart phone, or a head-mounted device configured to be worn by a user. In some embodiments, the computer device further comprises: a network interface in communication with an external device. In some embodiments, the network interface and the database module are configured to: receive from the external device, the information of the at least one parking meter. In some embodiments, the external device is the at least one parking meter or a central parking database. In some embodiments, the computer device further comprises a projector or a display configured to present the overlaid information.

In still another aspect, disclosed here are non-transitory computer-readable media storing instructions that when executed by a processor of a computing device within an augmented reality parking system, performs a method generating augmented reality display related to parking, comprising: capturing a live view or a saved image of a real-world comprising at least one parking meter; producing an information layer, the information layer providing information of the at least one parking meter; and overlaying the information layer on the live view or the saved images.

In some embodiments, the non-transitory computer-readable medium further comprises: providing a control for interacting with the information layer. In some embodiments, the non-transitory computer-readable medium further comprises: updating the information layer in real-time. In some embodiments, the information is maintenance status, parking violation status, or vacancy status of the at least one parking meter. In some embodiments, the non-transitory computer-readable medium further comprises: receiving input from a user. In some embodiments, the input from the user allows the method to access to user's profile. In some embodiments, the information of the at least one parking meter is determined based on the user's profile. In some embodiments, the user is a maintenance technician, an enforcement officer, or a driver.

In one aspect, disclosed herein are augmented reality (AR) systems for maintaining a plurality of parking meters using an AR maintenance application, the AR system comprising: a) a server configured to: i) receive data from the plurality of parking meters; and ii) generate maintenance status information; and b) a mobile device comprising: i) a camera configured to capture a live view or a saved image of a real-world comprising at least one of the plurality of parking meters; ii) a screen; and iii) the AR maintenance application configured to: A) control the camera to capture the live view or the saved image; B) produce a maintenance status information layer comprising the maintenance status information of the at least one of the plurality of parking meters; and C) overlay, on the screen, the maintenance status information layer on the live view or the saved image.

In some embodiments, the maintenance status information layer comprises a maintenance warning icon hovering around the at least one of the plurality of parking meters. In some embodiments, the maintenance warning icon comprises a symbol indicating number of maintenance malfunctions for the at least one of the plurality of parking meters. In some embodiments, the mobile device further comprises a control circuity configured to allow a user of the mobile device to interact with the mobile device. In some embodiments, the control circuity is further configured to: a) receive instructions from the user; and b) display, on the screen, at least one malfunction icon indicating type of the malfunction of the at least one of the plurality of parking meters. In some embodiments, the AR maintenance application is configured to update the maintenance status information in real-time. In some embodiments, each of the plurality of parking meters is configured to communicate the maintenance information to the server, and wherein the maintenance information is stored in a parking meter database. In some embodiments, the maintenance status information covers a specific area. In some embodiments, the specific area is a street, a block, an intersection, a parking garage, or a neighborhood. In some embodiments, the mobile device is further configured to interrogate the maintenance status information of the at least one of the plurality of parking meters. In some embodiments, the maintenance status information comprises tools or parts required for each maintenance operation. In some embodiments, the maintenance status information comprises alert for a user of the mobile device to take or abandon each maintenance operation.

In one aspect, disclosed herein are augmented reality (AR) systems for enforcing parking time at a plurality of parking meters using an AR parking time enforcement application, the AR system comprising: a) a server configured to: i) receive data from the plurality of parking meters; and ii) generate parking time information; and b) a mobile device comprising: i) a camera configured to capture a live view or a saved image of a real-world comprising at least one of the plurality of parking meters; ii) a screen; and iii) the AR parking time enforcement application configured to: A) control the camera to capture the live view or the saved image; B) produce a parking time information layer comprising the parking time information of the at least one of the plurality of parking meters; and C) overlay, on the screen, the parking time information layer on the live view or the saved image.

In some embodiments, the parking time information layer comprises an enforcement timer icon hovering around the at least one of the plurality of parking meters. In some embodiments, the enforcement timer icon display information of parking time for the at least one of the plurality of parking meters. In some embodiments, the information of parking time is remaining parking time, time exceeding purchased parking time, remaining grace period after expiry of the purchased parking time, or an indication that the purchased parking time expired recently. In some embodiments, the enforcement timer icon is color-coded for status of purchased parking time for the at least one of the plurality of parking meters. In some embodiments, the at least one of the plurality of parking meters is a single-space parking meter. In some embodiments, the AR parking time enforcement application is configured to update the parking time information in real-time. In some embodiments, each of the plurality of parking meters is configured to communicate the parking time information to the server, and wherein the parking time information is stored in a parking meter database.

In one aspect, disclosed herein are augmented reality (AR) systems for enforcing parking regulations at a plurality of parking meters using an AR parking regulation enforcement application, the AR system comprising: a) a server configured to: i) receive data from the plurality of parking meters and parking pay stations; and ii) generate parking citation information; and b) a mobile device comprising: i) a camera configured to capture a live view or a saved image of a real-world comprising a specific area, wherein the plurality of parking meters are located at or near the specific area; ii) a screen; and iii) the AR parking regulation enforcement application configured to: A) control the camera to capture the live view or the saved image; B) produce a parking citation information layer comprising the parking citation information of the plurality of parking meters; and C) overlay, on the screen, the parking citation information layer on the live view or the saved image.

In some embodiments, the parking citation information layer comprises a first citation icon hovering at a first section of the specification area. In some embodiments, the first citation icon comprises a symbol indicating number of parking citations for the first section of the specific area. In some embodiments, the mobile device further comprises a control circuity configured to allow a user of the mobile device to interact with the mobile device. In some embodiments, the live view or the saved image comprises a multi-space pay station in the specific area, wherein at least a fraction of the plurality of parking meters are managed by the multi-space pay station, and wherein the parking citation information layer comprises a first citation icon hovering at the multi-space pay station. In some embodiments, the first citation icon comprises a symbol indicating number of parking citations for the fraction of the plurality of parking meters managed by the multi-space pay station. In some embodiments, the mobile device further comprises a control circuity configured to allow a user of the mobile device to interact with the mobile device. In some embodiments, the control circuity is further configured to: a) receive instructions from the user; and b) display, on the screen, detailed information of the parking citations for the fraction of the plurality of parking meters managed by the multi-space pay station. In some embodiments, the detailed information of the parking citations is pay-by-parking space citations, wherein the overlay is a pay-by-parking space grid overlay, wherein each member of the grid represents a distinct single parking space, and wherein at least one member of the grid shows a parking citation. In some embodiments, the control circuity is further configured to display, on the screen, detailed parking citation for the at least one member of the pay-by-space grid, the detailed parking citation comprising a parking space number and an enforcement timer for the distinct single parking space. In some embodiments, the enforcement timer displays time passed since expiry of purchased parking time. In some embodiments, the detailed information of the parking citations is pay-by-license plate citations, wherein the overlay is a pay-by-license plate grid overlay, wherein each member of the grid represents a distinct license plate, and wherein at least one member of the grid shows a parking citation. In some embodiments, the control circuity is further configured to display, on the screen, detailed parking citation for the at least one member of the pay-by-license plate grid, the detailed parking citation comprising the distinct license plate and an enforcement timer for the distinct license plate. In some embodiments, the enforcement timer displays time passed since expiry of purchased parking time. In some embodiments, the AR parking regulation enforcement application is configured to update the parking citation information in real-time. In some embodiments, each of the plurality of parking meters is configured to communicate the parking citation information to the server, and wherein the parking citation information is stored in a parking meter database. In some embodiments, the specific area is a street, a block, an intersection, a parking garage, or a neighborhood. In some embodiments, the mobile device is further configured to interrogate the parking citation information of at least one of the plurality of parking meters.

In one aspect, disclosed herein are methods for maintaining a plurality of parking meters using an augmented reality (AR) maintenance application running on a mobile device comprising a camera and a screen, the method comprising: a) controlling the camera to capture a live view or a saved image of a real-world comprising at least one of the plurality of parking meters; b) receiving, by the mobile device, maintenance status information of the at least one of the plurality of parking meters from a server, wherein the server is configured to: i) receive data from the plurality of parking meters; and ii) generate the maintenance status information; c) producing a maintenance status information layer comprising the maintenance status information of the at least one of the plurality of parking meters; and d) overlaying, on the screen, the maintenance status information layer on the live view or the saved image.

In some embodiments, the maintenance status information layer comprises a maintenance warning icon hovering around the at least one of the plurality of parking meters. In some embodiments, the maintenance warning icon comprises a symbol indicating number of maintenance malfunctions for the at least one of the plurality of parking meters. In some embodiments, the mobile device further comprises a control circuity configured to allow a user of the mobile device to interact with the mobile device. In some embodiments, then method further comprises: e) receiving instructions from the user; and f) displaying, on the screen, at least one malfunction icon indicating type of the malfunction of the at least one of the plurality of parking meters. In some embodiments, the method further comprises: updating the maintenance status information in real-time. In some embodiments, the method further comprises: e) communicating the data from the plurality of parking meters to the server, the data comprising individual maintenance information of each of the plurality of parking meters; and f) storing the data comprising the individual maintenance information of each of the plurality of parking meters in a parking meter database. In some embodiments, the maintenance status information covers a specific area. In some embodiments, the specific area is a street, a block, an intersection, a parking garage, or a neighborhood. In some embodiments, the method further comprises: interrogating, by the mobile device, the maintenance status information from the at least one of the plurality of parking meters. In some embodiments, the maintenance status information comprises tools or parts required for each maintenance operation. In some embodiments, the maintenance status information comprises an alert for a user of the mobile device to take or abandon each maintenance operation.

In another aspect, disclosed herein are methods for enforcing parking time at a plurality of parking meters using an augmented reality (AR) parking time enforcement application running on a mobile device comprising a camera and a screen, the method comprising: a) controlling the camera to capture a live view or a saved image of a real-world comprising at least one of the plurality of parking meters; b) receiving, by the mobile device, parking time information of the at least one of the plurality of parking meters from a server, wherein the server is configured to: i) receive data from the plurality of parking meters; and ii) generate the parking time information; c) producing a parking time information layer comprising the parking time information of the at least one of the plurality of parking meters; and d) overlaying, on the screen, the parking time information layer on the live view or the saved image.

In some embodiments, the parking time information layer comprises an enforcement timer icon hovering around the at least one of the plurality of parking meters. In some embodiments, the enforcement timer icon displays information of parking time for the at least one of the plurality of parking meters. In some embodiments, the information of parking time is remaining parking time, time exceeding purchased parking time, remaining grace period after expiry of the purchased parking time, or an indication that the purchased parking time expired recently. In some embodiments, the enforcement timer icon is color-coded for status of purchased parking time for the at least one of the plurality of parking meters. In some embodiments, the at least one of the plurality of parking meters is a single-space parking meter. In some embodiments, the method further comprises: updating the parking time information in real-time. In some embodiments, the method further comprises: e) communicating the data from the plurality of parking meters to the server, the data comprising individual maintenance information of each of the plurality of parking meters; and f) storing the data comprising the individual maintenance information of each of the plurality of parking meters in a parking meter database.

In still another aspect, disclosed herein are methods for enforcing parking regulations at a plurality of parking meters using an augmented reality (AR) parking regulation enforcement application on a mobile device comprising a camera and a screen, the method comprising: a) controlling the camera to capture a live view or a saved image of a real-world comprising a specific area, wherein the plurality of parking meters are located at or near the specific area; b) receiving, by the mobile device, parking citation information of the specific area from a server, wherein the server is configured to: i) receive data from the plurality of parking meters; and ii) generate the parking citation information; c) producing a parking citation information layer comprising the parking citation information of the plurality of parking meters; and d) overlaying, on the screen, the parking citation information layer on the live view or the saved image.

In some embodiments, the parking citation information layer comprises a first citation icon hovering at a first section of the specification area. In some embodiments, the first citation icon comprises a symbol indicating number of parking citations for the first section of the specific area. In some embodiments, the mobile device further comprises a control circuity configured to allow a user of the mobile device to interact with the mobile device. In some embodiments, the live view or the saved image comprises a multi-space pay station in the specific area, wherein at least a fraction of the plurality of parking meters are managed by the multi-space pay station, and wherein the parking citation information layer comprises a first citation icon hovering at the multi-space pay station. In some embodiments, the first citation icon comprises a symbol indicating number of parking citations for the fraction of the plurality of parking meters managed by the multi-space pay station. In some embodiments, the mobile device further comprises a control circuity configured to allow a user of the mobile device to interact with the mobile device. In some embodiments, the method further comprises: e) receiving instructions from the user; and f) displaying, on the screen, detailed information of the parking citations for the fraction of the plurality of parking meters managed by the multi-space pay station. In some embodiments, the detailed information of the parking citations is pay-by-parking space citations, wherein the overlay is a pay-by-parking space grid overlay, wherein each member of the grid represents a distinct single parking space, and wherein at least one member of the grid shows a parking citation. In some embodiments, the method further comprises: displaying, on the screen, detailed parking citation for the at least one member of the pay-by-parking space grid, the detailed parking citation comprising a parking space number and an enforcement timer for the distinct single parking space. In some embodiments, the method further comprises: displaying, by the enforcement timer, time passed since expiry of purchased parking time. In some embodiments, the detailed information of the parking citations is pay-by-license plate citations, wherein the overlay is a pay-by-license plate grid overlay, wherein each member of the grid represents a distinct license plate, and wherein at least one member of the grid shows a parking citation. In some embodiments, the method further comprises: displaying, on the screen, detailed parking citation for the at least one member of the pay-by-license plate grid, the detailed parking citation comprising the distinct license plate and an enforcement timer for the distinct license plate. In some embodiments, the method further comprises: displaying, by the enforcement timer, time passed since expiry of purchased parking time. In some embodiments, the method further comprises: updating the parking citation information in real-time. In some embodiments, the method further comprises: e) communicating the data from the plurality of parking meters to the server, the data comprising individual parking citation information of each of the plurality of parking meters; and f) storing the data comprising the individual parking citation information of each of the plurality of parking meters in a parking meter database. In some embodiments, the specific area is a street, a block, an intersection, a parking garage, or a neighborhood. In some embodiments, the method further comprises, by the mobile device, interrogating the parking citation information of at least one of the plurality of parking meters.

In one aspect, disclosed herein is a non-transitory computer-readable storage medium storing executable computer program instructions, the instructions executable by at least one processor of a mobile device to maintain a plurality of parking meters using an augmented reality (AR) maintenance application by performing at least the following: a) controlling a camera to capture a live view or a saved image of a real-world comprising at least one of the plurality of parking meters, wherein the mobile device comprises the camera and a screen; b) receiving, by the mobile device, maintenance status information of the at least one of the plurality of parking meters from a server, wherein the server is configured to: i) receive data from the plurality of parking meters; and ii) generate the maintenance status information; c) producing a maintenance status information layer comprising the maintenance status information of the at least one of the plurality of parking meters; and d) overlaying, on the screen, the maintenance status information layer on the live view or the saved image.

In some embodiments, the instructions are further executable to perform the steps of: e) displaying, on the screen, a maintenance warning icon hovering around the at least one of the plurality of parking meters on the maintenance status information layer; f) displaying, on the screen, a symbol indicating number of maintenance malfunctions for the at least one of the plurality of parking meters on the maintenance status information layer; g) allowing a user of the mobile device to interact with the mobile device; h) receiving instructions from the user; i) displaying, on the screen, at least one malfunction icon indicating type of the malfunction of the at least one of the plurality of parking meters on the maintenance status information layer; and j) updating the maintenance status information in real-time.

In some embodiments, the instructions are further executable to perform the steps of: e) interrogating, by the mobile device, the maintenance status information from the at least one of the plurality of parking meters; f) displaying the maintenance status information comprising tools or parts required for each maintenance operation; and g) alerting a user of the mobile device to take or abandon each maintenance operation.

In another aspect, disclosed herein is a non-transitory computer-readable storage medium storing executable computer program instructions, the instructions executable by at least one processor of a mobile device to enforce parking time at a plurality of parking meters using an augmented reality (AR) parking time enforcement application by performing at least the following: a) controlling a camera to capture a live view or a saved image of a real-world comprising at least one of the plurality of parking meters, wherein the mobile device comprises the camera and a screen; b) receiving, by the mobile device, parking time information of the at least one of the plurality of parking meters from a server, wherein the server is configured to: i) receive data from the plurality of parking meters; and ii) generate the parking time information; c) producing a parking time information layer comprising the parking time information of the at least one of the plurality of parking meters; and d) overlaying, on the screen, the parking time information layer on the live view or the saved image.

In some embodiments, the instructions are further executable to perform the steps of: e) displaying, on the screen, an enforcement timer icon hovering around the at least one of the plurality of parking meters on the parking time information layer; f) displaying, on the screen, information of parking time for the at least one of the plurality of parking meters on the parking time information layer; g) displaying, on the screen, remaining parking time, time exceeding purchased parking time, remaining grace period after expiry of the purchased parking time, or an indication that the purchased parking time expired recently on the parking time information layer; h) displaying, on the screen, a color-coded enforcement timer icon for status of purchased parking time for the at least one of the plurality of parking meters on the parking time information layer; and i) updating the parking time information in real-time.

In still another aspect, disclosed herein is non-transitory computer-readable storage medium storing executable computer program instructions, the instructions executable by at least one processor of a mobile device to enforce parking regulations at a plurality of parking meters using an augmented reality (AR) parking regulation enforcement application by performing at least the following: a) controlling a camera to capture a live view or a saved image of a real-world comprising a specific area, wherein the plurality of parking meters are located at or near the specific area, and wherein the mobile device comprises the camera and a screen; b) receiving, by the mobile device, parking citation information of the specific area from a server, wherein the server is configured to: i) receive data from the plurality of parking meters; and ii) generate the parking citation information; c) producing a parking citation information layer comprising the parking citation information of the plurality of parking meters; and d) overlaying, on the screen, the parking citation information layer on the live view or the saved image.

In some embodiments, the instructions are further executable to perform the steps of: e) displaying, on the screen, a first citation icon hovering at a first section of the specification area on the parking citation information layer; f) displaying, on the screen, a symbol indicating number of parking citations for the first section of the specific area on the parking citation information layer; g) allowing a user of the mobile device to interact with the mobile device; and h) receiving instructions from the user.

In some embodiments, the instructions are further executable to perform the steps of: displaying, in the live view or the saved image, a multi-space pay station in the specific area, wherein at least a fraction of the plurality of parking meters are managed by the multi-space pay station, and wherein the parking citation information layer comprises a first citation icon hovering at the multi-space pay station.

In some embodiments, the instructions are further executable to perform the steps of: e) displaying, on the screen, a symbol indicating number of parking citations for the fraction of the plurality of parking meters managed by the multi-space pay station on the parking citation information layer; and f) displaying, on the screen, detailed information of the parking citations for the fraction of the plurality of parking meters managed by the multi-space pay station on the parking citation information layer.

In some embodiments, the instructions are further executable to perform the steps of: g) displaying, on the screen and for pay-by-parking space citations, a pay-by-parking space grid overlay on the parking citation information layer, wherein each member of the grid represents a distinct single parking space, and wherein at least one member of the grid shows a parking citation; h) displaying, on the screen and for the pay-by-parking space citations, detailed parking citation for the at least one member of the pay-by-parking space grid; i) displaying, on the screen and for the pay-by-parking space citations, a parking space number and an enforcement timer for the distinct single parking space; and j) displaying, on the screen and for the pay-by-parking space citations, time passed since expiry of purchased parking time on the enforcement timer.

In some embodiments, the instructions are further executable to perform the steps of: g) displaying, on the screen and for pay-by-license plate citations, a pay-by-license plate grid overlay on the parking citation information layer, wherein each member of the grid represents a distinct license plate, and wherein at least one member of the grid shows a parking citation; h) displaying, on the screen and for pay-by-license plate citations, detailed parking citation for the at least one member of the pay-by-license plate grid; i) displaying, on the screen and for pay-by-license plate citations, the distinct license plate and an enforcement timer for the distinct license plate; and j) displaying, on the screen and for pay-by-license plate citations, time passed since expiry of purchased parking time on the enforcement timer.

In some embodiments, the instructions are further executable to perform the steps of: e) updating the parking citation information in real-time; and f) interrogating, by the mobile device, individual parking citation information related to at least one of the plurality of parking meters.

### BRIEF DESCRIPTION OF THE DRAWINGS

The novel features of the subject matter described herein are set forth with particularity in the appended claims. A better understanding of the features and advantages of the present subject matter will be obtained by reference to the following detailed description that sets forth illustrative embodiments, in which the principles of the subject matter described herein are utilized, and the accompanying drawings of which:

FIG. 1 shows a non-limiting example of an operation diagram for an augmented reality parking device performing maintenance of parking meters;

FIG. 2 shows a non-limiting example of an operation diagram for an augmented reality parking device enforcing parking regulations;

FIG. 3 shows a non-limiting example of an operation diagram for an augmented reality parking directing parking enforcement actions;

FIG. 4 shows an operation diagram for an augmented reality parking device enforcing parking regulations at a pay-by-space parking lot;

FIG. 5 shows an operation diagram for an augmented reality parking device enforcing parking regulations at a pay-by-plate parking lot;

FIG. 6 shows block representation of an example augmented reality parking system configured and operated in accordance with some embodiments; and

FIG. 7 shows a block representation of an example augmented reality parking device configured in accordance with some embodiments.

### DETAILED DESCRIPTION OF THE INVENTION

Parking meters and parking stations need regular maintenance. For example, the mechanisms in the traditional parking meters need to be regularly oiled to keep them from sticking. During the winter season when meters are subject to colder temperatures, such problems become worse. For parking meters that are battery power, a dead or malfunctioned battery needs to be replaced or replenished. Vandalism is another source of malfunctioned parking meters. Sometimes parking enforcement officers report information of observed non-working parking meters to the maintenance department. Other times, a meter is out of service for days or weeks before being reported. A non-functional parking meter does not bring in revenue for the parking authority. In addition, even if a broken meter is reported, timely service is not provided because the maintenance worker does not know the details of the broken meter so that he does not bring the appropriate tools/parts to the broken meter. A more effective way is needed to locate broken parking meters on the street and recognize the services they need.

Drivers, especially non-local drivers, sometimes have hard time securing parking spaces at or near their destination. Aimless driving around a full parking lot not only waste time and pollute the environment, the frustration may also escalate to violent behaviors or parking violations. A more user-friendly way to help drivers to find vacant parking space is needed to fulfil the purpose of metered parking in the cities.

Effective enforcement of parking regulations falls on the shoulders of park enforcement officers. The enforcement agencies face technical challenges to catch parking violators because current technologies associated with parking enforcement are not based on realtime parking status at each parking space. The same enforcement technologies are also time-consuming for the enforcement agencies to track down violators and issue tickets. For example, one newspaper reports that Detroit spends more money issuing parking fines than it collects from them in 2014. Traditionally, enforcement officers walk on the street and check parking meters one after another to find expired ones. This is inefficient and time-consuming in that the enforcement office spends more time checking unexpired meters than checking expired ones. Lost time means fewer parking tickets are issued to violators and lost revenues. Another compounding issue is that, before walking down a street, the enforcement office has no idea how many parking violations there are on the nearby streets or whether there are different types of violations. For example, an enforcement officer is issuing a parking ticket of $20 for a vehicle parked next to an expired meter. One block away, an unauthorized vehicle parks on a parking space reserved for the handicapped. The penalty for such a serious parking violation is $150. Thus, there is a need to develop and implement technologies related to parking enforcement in order to reduce the occurrence of afore-mentioned problems and to facilitate efficient enforcement mechanisms of parking regulations, allowing, for example, real time identification of parking violators.

The present disclosure generally relates to an augmented reality parking system that superimpose the digital content, i.e., the parking status of at least one parking target, onto the image of the corresponding parking target displayed an augmented reality parking device. The augumented reality parking device further performs a plurality of operations depending on the displayed parking status of the at least one parking target. The augumented realtity parking device allows a user to access more digital content about other parking targets, thereby assisting the user to decide an action on one of the parking targets.

Advancement of digital reality beyond the gaming industry has progressed to the stage where direct or indirect live views of the physical world have been augmented with superimposed computer-generated images/icons over a user's view of the same physical world, thereby enhancing the user's perception of reality in various ways. For example, augmented reality applications have been implemented by mobile computing systems, including, for example, smart phones, tablets, in-vehicle displays, other types of wireless computing devices such as wearable glasses and interactive glasses that can explore the real world with added information from the digital world, police officer body cameras, and police vehicle cameras. The digital information that is augmented to the real world includes graphics, audio and other sensory enhancements over a real-world environment in real time. User interaction with the digital information is allowed, thereby allowing the user to either explore or ignore the displayed augmented information.

Single-space and multiple-space parking meters, including electronic meters, have included sensors that detect and provide real-time parking information to central parking management via wireless communications systems. For example, a parking meter can comprise a wireless radio or antenna which transmits signals to and receive signals from external devices, including, for example, various databases described elsewhere. In some embodiments, the transmission is wireless communications. For example, in some embodiments, the wireless communications are enabled by near-field communication (NFC), Bluetooth, Wi-Fi, Global System for Mobile communications (GSM), Code Division Multiple Access (CDMA), Long-Term Evolution (LTE), cellular telephone, satellite, or other IP embedded wireless communications. In some cases, the external device is a central parking management, another parking meter, a regional communication center, a vehicle sensor, traffic/red-light cameras, traffic lights or other city infrastructure, a mobile device (such as a smart phone), wireless technology embedded in the vehicle itself, city wireless infrastructure including, for example, Wi-Fi networks, mesh networks, Low-Power Wide-Area Network (LPWAN) or Low-Power Network (LPN), or other proprietary wireless Internet of Things (IoT) networks. In further embodiments, the external device is an augmented reality parking device described elsewhere. In some embodiments, the parking meter comprises a passive RFID tag or visual marker, such as a QR/2D code, which is configured to allow interrogation for the purposes of establishing contact with or providing information to the augmented reality parking device. The information broadcast includes GPS position of the parking meter, status of the parking meter, violation codes for the vehicle involved, malfunction code for the parking meter, unique identification code for the parking meter, etc.

In some embodiments, sensors at designated parking spaces enable detection of illegal parking activities, including, for example, unauthorized parking at a handicapped zone or a space reserved for an expecting mother; obstructing driveway, parking at a loading zone, single vehicle occupying two parking spaces, parking on sidewalk, parked vehicle with delinquent parking tickets, etc. In some cases, sensors are overhead cameras with OCR and AI capabilities to detect vehicle or license plate information, including those installed in traffic intersections, light poles, and security cameras at stores, public places, or homes. In some cases, sensors detect malfunctions of the parking meter, including, for example, a leaking battery, a jammed printer, a blocked coin canister, etc. In some embodiments, a parking meter comprises a computer device, an antenna, or a wireless radio, to broadcast information of or received by the parking meter to enforcement agencies or maintenance technicians. In some embodiments, an enforcement agent or a maintenance technician uses an augmented reality parking device to interrogate parking information broadcast by the parking meter. In some embodiments, parking status or maintenance status of a specific area, such as, for example, a street, four blocks, a parking garage, a neighborhood, is available for downloading from a database or a web site, and is in a format for application of augmented reality technologies. In some embodiments, the parking status or maintenance of a specific area, such as, for example, a street, four blocks, a parking garage, a neighborhood, is available on a user's mobile device or a computer.

Described here, in certain embodiments, are computer-implemented methods for generating augmented reality display related to parking, comprising: capturing a live view or a saved image of a real-world comprising at least one parking meter; producing an information layer, the information layer providing information of the at least one parking meter; and overlaying the information layer on the live view or the saved image.

Also described herein, in certain embodiments, are disclosed herein are computing devices within an augmented reality parking system, comprising: a power source; a memory; a camera; a database module configured to access information of at least one parking meter; and a digital content processor configured to: capture a live view or a saved image of a real-world comprising the at least one parking meter; produce an information layer, the information layer providing information of the at least one parking meter, the information retrieved by the database module; and overlay the information layer on the live view or the saved image.

Also described herein, in certain embodiments, are non-transitory computer-readable media storing instructions that when executed by a processor of a computing device within an augmented reality parking system, performs a method generating augmented reality display related to parking, comprising: capturing a live view or a saved image of a real-world comprising at least one parking meter; producing an information layer, the information layer providing information of the at least one parking meter; and overlaying the information layer on the live view or the saved images.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, the term “parking target” generally refers to a single-space parking meter, a multi-space parking meter, a parking pay station, a parking space, a parking lot, a garage, or a gateway that receive information from multiple parking spaces and transmitting such information to a wireless network.

As used herein, the term “augmented reality,” or “AR,” generally refers to an interactive experience of a real-world environment whereby the objects that reside in the real-world are augmented by computer-generated perceptual information.

### Augmented Reality Parking System

In some embodiments, the methods, systems, and platforms described herein include an augmented reality parking system, or the use of the same. In some embodiments, an augmented reality parking system comprises an augmented reality parking device.

In some instances, the system comprises a central processing unit (CPU), memory (e.g., random access memory, flash memory), electronic storage unit, computer program, communication interface to communicate with one or more other systems, and any combination thereof. In some instances, the system is coupled to a computer network, for example, the Internet, intranet, and/or extranet that is in communication with the Internet, a telecommunication, or data network. In some embodiments, the system comprises a storage unit to store data and information regarding any aspect of the methods described in this disclosure.

In some embodiments, the system comprises a cloud-back end (e.g., cloud portal). In some instances, the cloud back-end is configured as the API EndPoint, receiving data from the user's AR session from the AR application (e.g., the AR maintenance application, the AR parking time enforcement application, or the AR parking regulation enforcement application). In some embodiments, the electronic device of the system (e.g., the server, the AR parking device, including the mobile device) is configured to communicate with the cloud back-end. Various aspects of the system are a product or article or manufacture.

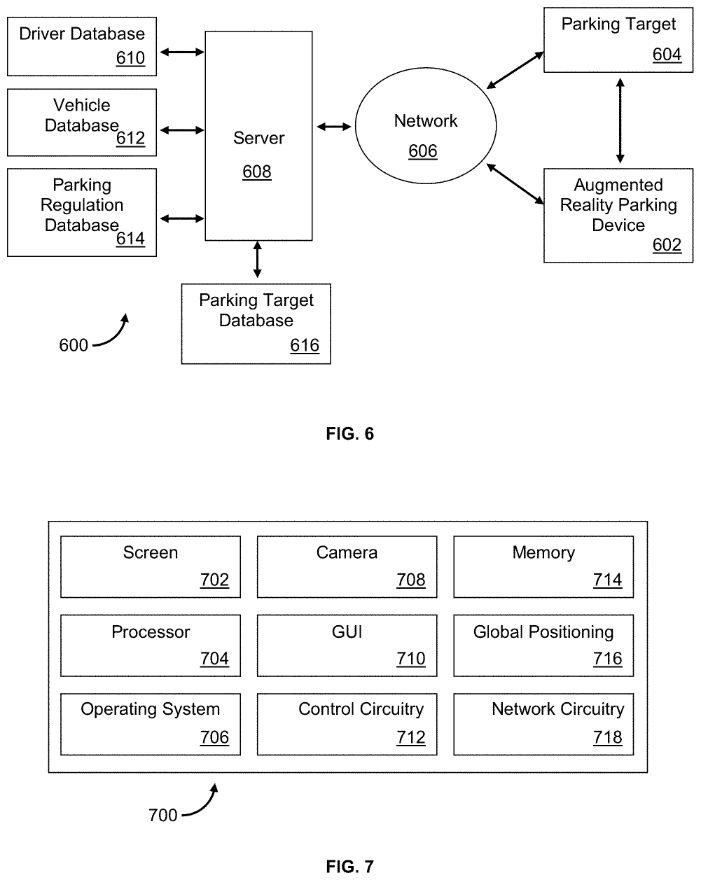

FIG. 6 generally illustrates an example augmented reality parking system 600 that can utilize an augmented reality parking device 602 according to the present disclosure. The augmented reality parking device 602 may be configured to be any physical dimension, capacity, and computing speed such that it can perform stand-alone computing operations, including, for example, taking pictures of a parking target 604, scanning Quick Response (QR) code or two-dimensional (2D) barcode of the parking target 604; communications operations, such as, for example, communicating with parking target 604, interrogating information broadcast by the parking target 604; network operations such as, for example, establishing uploading and downloading connection with a wired or wireless network 606 via appropriate protocols, and accessing a remote server 608 (e.g., a central parking management server). The remote server 608 can have access to various databases, including, for example a driver database 610 storing driver information, a vehicle database 612 storing vehicle information, a parking regulation database 614 storing parking regulations and special parking rules/announcement, and a parking target database 616.

In some embodiments, through the utilization of the network 606, the parking target 604 communicate with the server 608 and retrieve information from the various databases linked to the server 608 or deposit information to the various databases. For example, the parking target 604 can deposit meter maintenance information and parking violation information into the parking target database at the data block associated with the parking target.

In some embodiments, the augmented reality parking device 602 receives information from the parking target 604 directly. In other embodiments, the augmented realty parking device 602 can detect and send the unique identification code of the parking target 604 to the remote server 608, thereby retrieving information of the parking target associated with the unique identification code from the parking target database 614 through the network 606. In addition, through the utilization of the network 606, the augmented reality parking device 602 also has access to driver information from the driver database 610, vehicle information from the vehicle database 612, parking regulation information from the parking regulation database 614, or other information from other databases (not shown).

In some embodiments, the augmented reality parking device 602 receives violation information, including a violation code or number of violations, from the parking target 604 or from the parking target database 616. In other embodiments, the augmented reality parking device 602 receives maintenance information, including a malfunction code or number of malfunctions, from the parking target 604 or from the parking target database 616. In some embodiments, the augmented reality parking device 602 receives or recognizes the GPS coordinates of the parking target 604 and uses the GPS coordinates to retrieve maintenance information or parking violation information associated with the parking target 604. In some embodiments, the augmented reality parking device 602 uses its GPS coordinates to retrieve maintenance information or parking violation information associated with the parking target 604 at the same GPS coordinates or near the same GPS coordinates. In some embodiments, the augmented reality parking device 602 correlates actual, physical locations of the parking target 604 with digital content (e.g., maintenance information or parking violation) to assign the digital content to that particular parking target 604 at that physical location.

In some embodiments, the augmented reality parking device 602 projects artificial light onto a real world surface, allows for human interaction, senses the human interaction (i.e., touch of the projected light). In some embodiments, the augmented reality parking device 602 detects the physical movements of the user, (e.g., the movement of hands or eyeballs). In some embodiments, augmented reality parking device 602 performs functions based on the detected interactions with the user or the detected physical movements of the user. In some embodiments, some or all of the databases 610, 612, 614, 616 are available in a mobile device or a computer of the user. In other embodiments, some or all of the databases 610, 612, 614, 616 are available in the augmented reality parking device 602. In some cases, the AR parking device, for example, a mobile device, communicates with a parking meter or a parking pay station and receives update of parking information from the parking meter or the parking pay station as part of or supplement to the parking information from some or all of the databases 610, 612, 614, and 616. In some embodiment, the AR parking device 602 comprises the server 608, which becomes a local server.

In some embodiments, the augmented reality (AR) application runs entirely locally, e.g., at the AR parking device, such as, a mobile device. In such embodiments, steps of the various methods disclosed herein are performed by the AR application locally at the mobile device. Moreover, in such embodiments, the AR application operates in non-connected environments, e.g., remote environments where no (or only inadequate) Wi-Fi or cellular connectivity is available. In other embodiments, the AR application runs locally and the various steps of the methods described herein are performed locally at the mobile device; however, some or all of the outputs of the AR application, e.g., an AR image of a vehicle with expired parking time, are exported or uploaded to the cloud computing element. In yet other embodiments, the AR application runs locally and the various steps of the methods described herein are performed at the mobile device, but the parking data, e.g., parking citation information, is exported or uploaded to the cloud computing element for processing. In such embodiments, the processing steps, such as generating a citation ticket and sending the citation ticket electronically to the driver of the vehicle cited in the citation ticket, are performed at the cloud computing system.

### Augmented Reality Parking Device

In some embodiments, the methods, systems, and platforms described herein include an augmented reality parking device, or use of the same.

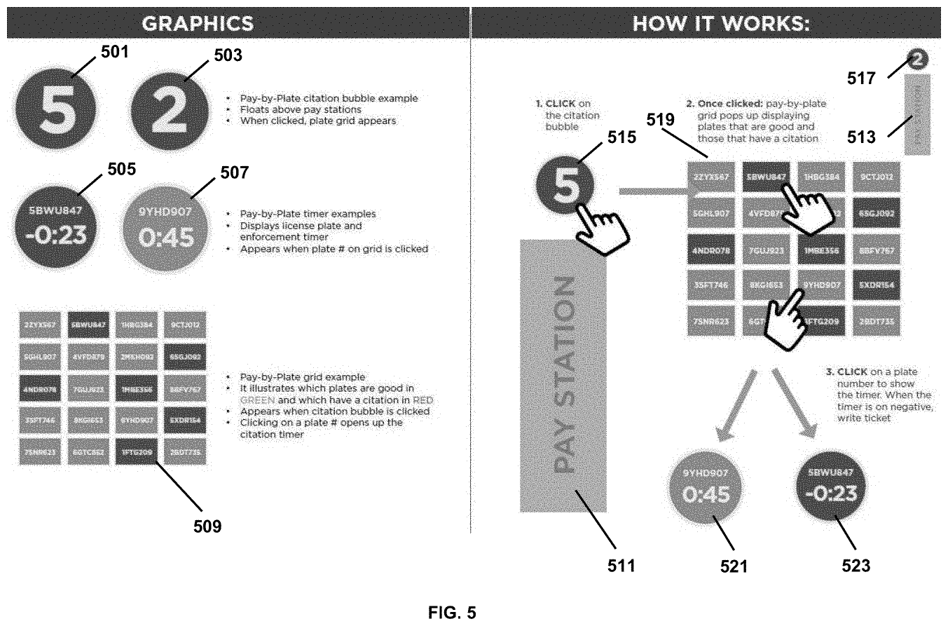

FIG. 7 is a block representation of an example augmented reality parking device 700 constructed and operated in accordance with some embodiments to provide digital content to specific parking target. The augmented reality parking device 700 is not limited to the configuration or constituent components shown in FIG. 7, but can correlate a parking target at a real-world location with its digital content using at least the components displayed in FIG. 5. At least one screen 702 can take data from one or more processors 704, images obtained by camera 708 of the parking target, and data from the memories 714 to organize and render visual digital content over either the images of the parking target or real-world views of the parking target.

Processor 704 and memory 714 can further cooperate with control circuity 712 and network circuity 718 to recognize a user's interaction with the digital content or his intention to interact with the digital content, thereby allowing the user to explore further the digital content associated with the particular parking target. For example, when the digital content displays two malfunctions for a particular parking meter, the user can interact with the digital content to display what are the two malfunctions and required tools/procedures to repair the each malfunction. The digital content rendered on screen 702 can be complemented by a graphical user interface (GUI) 710. The GUI 710 can control an operation system 706 to provide the user with options to interact with the displayed digital content, and decide the way the digital content is displayed or superimposed. The global positioning 716 can provide real-time GPS coordinates to the processor 704, the operating system 706, the memory 714, and the network circuity 718 for their operations, including, for example, properly superimposing the received digital content, identifying nearby parking targets, etc. The augmented reality parking device 700 can have at least one sensor (not shown) specifically detecting and/or interrogating signals broadcast by the parking target. Other embodiments of the augmented reality parking device are described elsewhere.

In some cases, the augmented reality parking device is a wearable device. In some cases, the augmented reality parking device is wearable AR glasses or smart glasses. In some cases, the augmented reality parking device is a wearable hat. In some cases, the augmented reality parking device is a wearable watch. In some cases, the augmented reality parking device is a wearable earphone or earbud. In some cases, the augmented reality parking device is a mobile phone or a smart phone.

### Augmented Reality Maintenance Methods

In some embodiments, the methods, systems and platforms described herein include an augmented reality maintenance method. In other embodiments, the augmented reality maintenance method comprises detecting parking targets and receiving maintenance status of parking targets. In some embodiments, the augmented reality maintenance method comprises receiving and displaying summary maintenance status of all parking targets in a specific area, such as, for example, total malfunctions for parking meters on a street, within four blocks, or in a parking garage. In other embodiments, the augmented reality maintenance method comprises receiving and displaying information of detailed maintenance demand for a single parking target, such as, a parking meter. In some embodiments, the augmented reality maintenance method comprises receiving and displaying repairing tools or parts required for each maintenance operation. In other embodiments, the augmented reality maintenance method comprises predicting future maintenance operations in view of the maintenance history of the parking target or based on the maintenance history of similar parking targets. In some embodiments, the augmented reality maintenance method comprises alerting the maintenance technician to take or abandon the maintenance operations due to presence or lack of repairing parts/tools/skills, etc.

In some embodiments, a maintenance technician uses an augmented reality parking device to interrogate maintenance information broadcast by the parking target. In other embodiments, the augmented reality parking device provides real time access to the database of parking targets and searches for the parking target of interest based on the RFID, QR code, 2D code, or other unique identifier of the parking target.

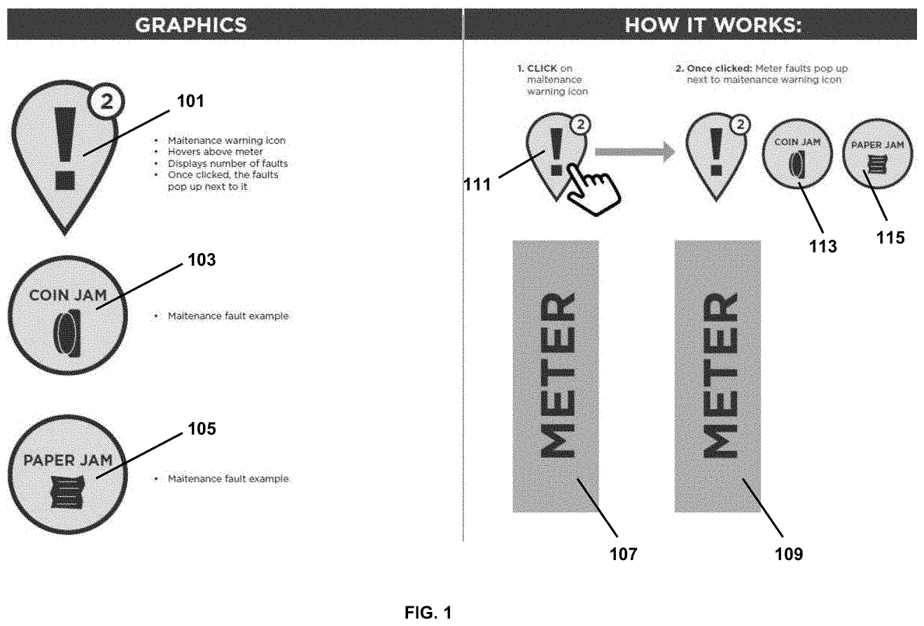

FIG. 1 shows a non-limiting example of an operation diagram for an augmented reality parking device to perform maintenance of parking meters. When a maintenance technician uses an augmented reality parking device in the vicinity of a plurality of parking meters, the augmented reality parking device displays maintenance information associated with each parking meter. In some embodiments, if a parking meter has maintenance issues, a graphic symbol 101 displays on top of or next to the parking meter. In other embodiments, the graphic symbol 101 is a maintenance warning icon and hovers above the parking meter. In some embodiments, the graphic symbol 101 displays number of faults for the parking meter. In some embodiments, the graphic symbol 101 can be clicked and, once it is clicked, the faults associated with the parking meter pop up next to the graphic symbol 101. For example, a graphic symbol 103 is a maintenance fault example of coin jam and a graphic symbol 105 is a maintenance fault example of paper jam for the receipt demonstrating the paid time or paid parking fees.

The maintenance technician finds two parking meters 107 and 109 on the side of the road. On top of the meter 107 hovers a maintenance warning icon 111 showing two faults of the parking meter 107. After the maintenance technician clicks on the maintenance warning icon 111, two meter faults 113 and 115 pop up next to the maintenance warning icon 111. Meter fault 113 indicates a coin jam and meter fault 115 indicates paper jam. After viewing the meter faults 113 and 115, the maintenance technician can decide how and when to repair the meter 107. In this way, the maintenance technician obtains real-time status of all the parking meter within his augmented reality view of the parking meters. The maintenance technician can ride a Segway through the street, stopping only at parking meters with maintenance warning icons hovering over them.

### Augmented Reality Parking Enforcement Methods

In some embodiments, the methods, systems and platforms described herein include an augmented reality parking enforcement method. In other embodiments, the augmented reality parking enforcement method comprises detecting parking targets and receiving parking violation status of parking targets. In some embodiments, the augmented reality parking enforcement method comprises receiving and displaying summary parking violation status of all parking targets in a specific area, such as, for example, total violations for parking meters on a street, within four blocks, or in a parking garage. In other embodiments, the augmented reality parking enforcement method comprises receiving and displaying information of detailed violations for a single parking target, such as, a parking meter. In some embodiments, the augmented reality parking enforcement method comprises receiving and displaying total fines for violations at a particular parking target, such as a parking meter. In other embodiments, the augmented reality parking enforcement method comprises predicting future parking violations in view of the parking violation history of the user of a parked vehicle at a parking target, based on the remaining parking time for a vehicle at a parking target, or based on the likelihood the parked vehicle will exceeds its purchase parking time. In some embodiments, the augmented reality parking enforcement method comprises alerting the enforcement officer to take or abandon the ticketing operations due to event-specific conditions, including, for example, charity events, drinking parties, and weddings.

In some embodiments, an enforcement officer uses an augmented reality parking device to interrogate parking violation information broadcast by the parking target. In other embodiments, the augmented reality parking device provides real time access to the database of parking targets and searches for the parking target of interest based on the RFID, QR code, 2D code, or other unique identifier of the parking target.

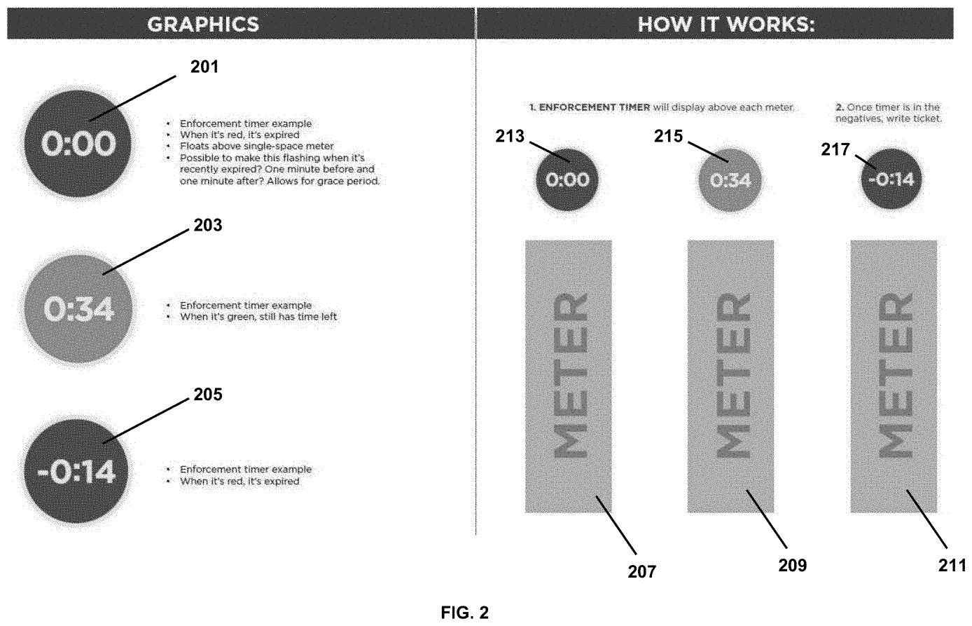

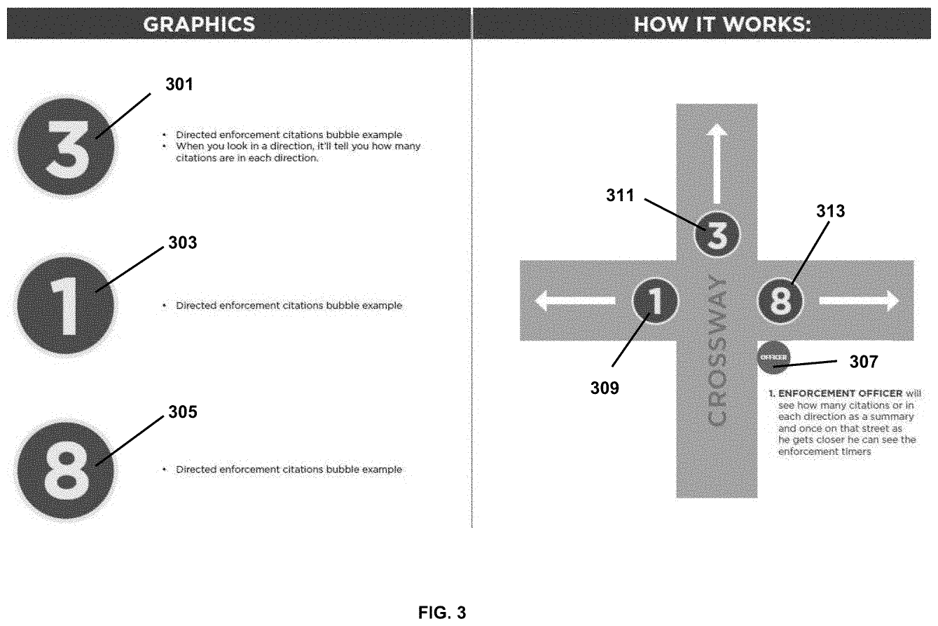

FIG. 2 shows a non-limiting example of an operation diagram for an augmented reality parking device enforcing parking regulations. When an enforcement office uses an augmented reality parking device in the vicinity of a plurality of parking meters, the augmented reality parking device displays parking violation information associated with each parking meter. In some embodiments, the augmented reality parking device displays parking timer information associated with each parking meter. In some embodiments, a graphic symbol 201 displays on top of or next to the parking meter. In other embodiments, the graphic symbol 201 is an enforcement time icon and hovers above the parking meter. In some embodiments, the graphic symbol 201 displays the parking time remaining or the parking time exceeds purchased time. In some embodiments, the graphic symbol 201 is red when the time expired. In some embodiments, the graphic symbol 201 floats above the single-space parking meter. In some embodiments, the graphic symbol 201 is flashing if the timer has expired no more than 5 minutes or the timer is going to expire in 5 minutes. In some embodiments, the graphic symbol 201 displays different colors during an allowed grace period. In some embodiments, a graphic symbol 203 is an enforcement timer example. In some embodiments, the graphic symbol 203 is green because there is parking time left. In some embodiments, a graphic symbol 205 is an enforcement timer example. In some embodiments, the graphic symbol 205 is red because the parking time has expired.

The enforcement officer finds three parking meters 207, 209, and 211 on the side of the road. On top of the meter 207 floats an enforcement timer icon 213 showing that the parking time just expired for the parking meter 207. On top of the meter 209 floats an enforcement timer icon 215 showing that there is still parking time left for the parking meter 209. On top of the meter 211 floats an enforcement timer icon 217 showing that he parking time has just expired for the parking meter 211. Accordingly, the enforcement office writes a ticket for the vehicle parked at the parking meter 211.

In this way, the enforcement office obtains real-time status of all the parking meters within his augmented reality view of the parking meters. The enforcement officer can ride a mountain bike through the street, stopping only at parking meters with expired timer icon hovering over them.

### Augmented Reality Pay-by-Space Parking Methods

In some embodiments, the methods, systems and platforms described herein include an augmented reality pay-by-space parking method. In other embodiments, the augmented reality pay-by-space method comprises detecting parking targets and receiving pay-by-space citation status of parking targets. In some embodiments, the augmented reality parking pay-by-space method comprises receiving and displaying summary pay-by-space citation status of all parking targets in a specific area, such as, for example, total citations or vacant spaces for parking meters on a street, within four blocks, or in a parking garage. In other embodiments, the augmented reality pay-by-space parking method comprises receiving and displaying information of detailed vacant sparking spaces for a single parking target, such as, a parking lot. In some embodiments, the augmented reality pay-by-space method comprises receiving and displaying total vacant spaces at a particular parking target, such as a parking lot. In other embodiments, the augmented reality pay-by-space parking method comprises predicting future vacant spaces in view of the parking history of the user of a parked vehicle at a parking target, based on the remaining parking time for a vehicle at a parking target, or based on the likelihood the parked vehicle will exceeds its purchase parking time. In some embodiments, the augmented reality pay-by-space parking method comprises alerting the enforcement officer to take or abandon the ticketing operations due to event-specific conditions, including, for example, charity events, drinking parties, and weddings. In some embodiments, an enforcement officer uses an augmented reality parking device to interrogate parking violation information broadcast by the parking target, such as, for example, a parking lot or parking garage.

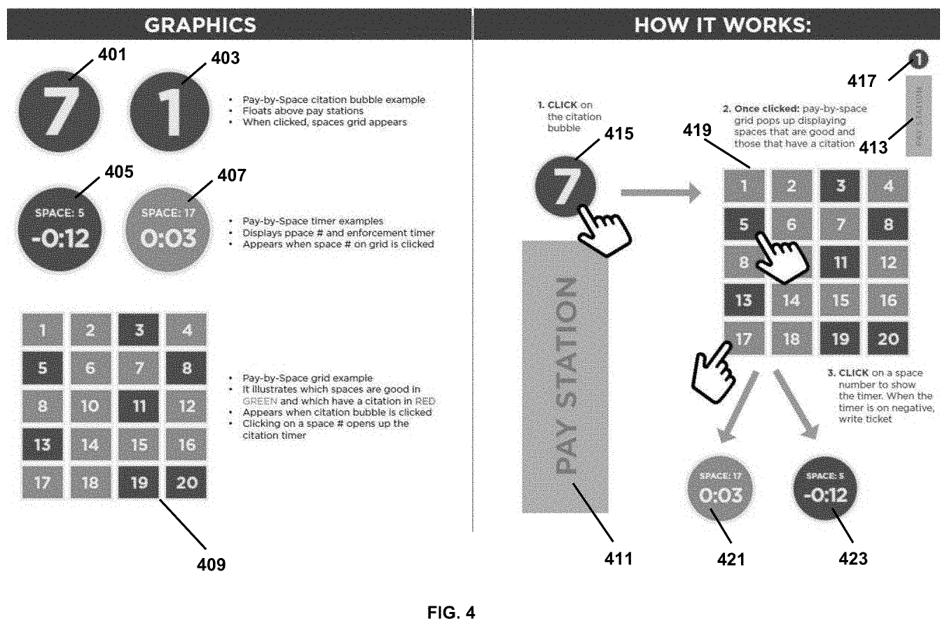

FIG. 4 shows an operation diagram for an augmented reality parking device enforcing parking regulations at a pay-by-space parking lot. When an enforcement office uses an augmented reality parking device in the vicinity of a parking pay station, the augmented reality parking device displays pay-by-space citation information associated with the parking pay station. In some embodiments, a graphic symbol 401 displays on top of or next to the parking pay station. In other embodiments, the graphic symbol 401 is a pay-by-space timer bubble and hovers above the parking pay station. In some embodiments, the graphic symbol 401 shows the number of pay-by-space citations within the parking lot. In some embodiments, the graphic symbol 401 is visible if the user looks in the direction of the pay-by space parking lot. In some embodiments, the graphic symbol 403 is a pay-by-space citations bubble example displaying the total number of parking citations (1). In some embodiments, when the graphic symbol 401 is clicked, a spaces grid 409 appears in the augmented reality parking device. Each of the graphic symbols 405 and 407 display parking space # and an enforcement timer associated with each parking space. More symbols appear when the space # on the grid is clicked.

The enforcement officer finds two pay stations 411 and 413 next to a stadium and both have citations. A pay-by-space bubble 415 showing 7 pay-by-space timer expired floats above the pay station 411. A pay-by-space bubble 417 showing 1 pay-by-space timer expired floats above the pay station 413. The enforcement officer clicks on the citation bubble 415, a pay-by-space grid 419 for the pay station is in. In some embodiments, the grid 419 displays spaces that have a citation and those that do not have a citation. In some embodiments, when the enforcement officer clicks on a space number, the pay-by-space timer shows. Accordingly, the enforcement office writes a citation for the vehicle that parks at the space and has expired time. In this way, the enforcement office obtains real-time status of all the parking pay stations within his augmented reality view of the parking pay stations.

In some embodiments, when a driver uses an augmented reality parking device in the vicinity of a parking pay station, the augmented reality parking device displays vacant spaces information associated with the parking pay station. In some embodiments, the drive click on the vacant space bubble which has the most vacant spaces, a grid shown the locations of each vacant space in the parking lot. In some embodiments, the augmented reality parking device compares parking rates and display the parking rates for different vacant parking spaces.

In some embodiments, the methods of using the augmented reality parking device are based on the user profile. In other embodiments, a user, be it a maintenance technician, an enforcement officer, or a driver, provides his user profile when first registers to use the augmented reality parking device. In some embodiments, the methods for using the augmented reality parking device provides different functions based on different user profiles. In other embodiments, when the augmented reality parking device starts, it requires a user logon and uses the user's profile for authorization purposes. In some embodiments, the user profile identifies the user as a maintenance technician, an enforcement officer, a driver, a police officer, an auditor, or other entities; and the methods provides user access to the corresponding sub-programs and applications accordingly. In other embodiments, the methods for using the augmented reality parking device project parking meter-related information from a computer device, such as, for example, a mobile phone, a smart phone, a computer, and a server, into the real world images or views relative to parking meters, including, for example, electronic parking meters, for the purposes of city workforce optimization. In some embodiments, the methods for using the augmented reality parking device are multi-faceted and applicable to maintenance of the parking meters, enforcement of parking regulations, cash collections, wireless payment collections, and parking assistance programs for drivers, etc. In other embodiments, the augmented reality parking device is a head-up display or heads-up display, also known as a HUD, which is a transparent display that presents data without requiring the user to look away from their usual viewpoints. In some embodiments, the HUD projects parking-related data onto the windshield of a vehicle, an in-vehicle video display, or a personal mobile phone of the user. In other embodiments, when users authorize certain operations, the augmented reality parking device permits different users communicate and share parking-related information from the same system or platform.

In some embodiments, because the same databases, parking meter information, parking information, and maintenance information are used for different types of users, the city clients (maintenance technicians and enforcement officers) and the consumer clients (drivers) operate the parking system of the city more efficiently. In some embodiments, the methods for using the augmented reality parking device allow drivers to report broken parking meters to the maintenance technicians, and to report illegal parking activities observed by the drivers to the enforcement officers. In other embodiments, efficiency data of using the methods are collected from different types of users who use the same program, same database, same or similar tools for their specific purposes. In some embodiments, the efficiency data are analyzed to optimize the performance of parking operations in the city, thereby improving convenience to the consumer (drivers) while, at the same time, providing tools for the city client (maintenance technicians and enforcement officers to conduct their operation more efficiently.

### Augmented Reality Pay-by-Plate Parking Methods

In some embodiments, the methods, systems and platforms described herein include an augmented reality pay-by-plate parking method. In other embodiments, the augmented reality pay-by-plate method comprises detecting parking targets and receiving pay-by-plate citation status of parking targets. In some embodiments, the augmented reality parking pay-by-plate method comprises receiving and displaying summary pay-by-plate citation status of all parking targets in a specific area, such as, for example, total vacant spaces or citations for parking meters on a street, within four blocks, or in a parking garage. In other embodiments, the augmented reality pay-by-plate parking method comprises receiving and displaying information of detailed vacant sparking spaces for a single parking target, such as, a parking lot. In some embodiments, the augmented reality pay-by-plate method comprises receiving and displaying total vacant spaces at a particular parking target, such as a parking lot. In other embodiments, the augmented reality pay-by-plate parking method comprises predicting future vacant spaces in view of the parking history of the user of a parked vehicle at a parking target, based on the remaining parking time for a vehicle at a parking target, or based on the likelihood the parked vehicle will exceeds its purchase parking time. In some embodiments, the augmented reality pay-by-plate parking method comprises alerting the enforcement officer to take or abandon the ticketing operations due to event-specific conditions, including, for example, charity events, drinking parties, and weddings. In some embodiments, an enforcement officer uses an augmented reality parking device to interrogate parking violation information broadcast by the parking target, such as, for example, a parking lot or parking garage.

FIG. 5 shows an operation diagram for an augmented reality parking device enforcing parking regulations at a pay-by-plate parking lot. When an enforcement office uses an augmented reality parking device in the vicinity of a parking pay station, the augmented reality parking device displays pay-by-plate citation information associated with the parking pay station. In some embodiments, a graphic symbol 501 displays on top of or next to the parking pay station. In other embodiments, the graphic symbol 501 is a pay-by-plate timer bubble and hovers above the parking pay station. In some embodiments, the graphic symbol 501 shows the number of pay-by-plate citations within the parking lot (5). In some embodiments, the graphic symbol 501 is visible if the user looks in the direction of the pay-by space parking lot. In some embodiments, the graphic symbol 503 is a pay-by-plate citations bubble example displaying the total number of parking citations (2). In some embodiments, when the graphic symbol 501 is clicked, a plate grid 509 appears in the augmented reality parking device. Each of the graphic symbols 505 and 507 display license plate # and an enforcement timer associated with each parking space. More symbols appear when the space # on the grid is clicked.

The enforcement officer finds two pay stations 511 and 513 near a build and both have citations. A pay-by-plate bubble 515 showing 5 pay-by-plate timer expired floats above the pay station 511. A pay-by-plate bubble 517 showing 2 pay-by-plate timer expired floats above the pay station 513. The enforcement officer clicks on the citation bubble 515, a pay-by-space grid 519 for the pay station is in. In some embodiments, the grid 519 displays spaces that have a citation and those that do not have a citation. In some embodiments, when the enforcement officer clicks on a space number, the pay-by-plate timer shows. Accordingly, the enforcement office writes a citation for the vehicle that parks at the space and has expired time. In this way, the enforcement office obtains real-time status of all the parking pay stations within his augmented reality view of the parking pay stations.

In some embodiments, when a driver uses an augmented reality parking device in the vicinity of a parking pay station, the augmented reality parking device displays vacant spaces information associated with the parking pay station. In some embodiments, the drive click on the vacant space bubble which has the most vacant spaces, a grid shown the locations of each vacant space in the parking lot. In some embodiments, the augmented reality parking device compares parking rates and display the parking rates for different vacant parking spaces.

In some embodiments, an augmented reality parking device comprises a power source. In further embodiments, the power source comprises a battery. In further embodiments, the power source comprises a wireless charging module.

In other embodiments, an augmented reality parking device comprises a wireless communications module configured to communicate a unique identifier to an external device, the identifier associated in an external database with a parking target. In some embodiments, the wireless communications module is near-field communication (NFC) module, Bluetooth module, Wi-Fi module, Global System for Mobile communications (GSM) module, Code Division Multiple Access (CDMA) module, Long-Term Evolution (LTE) module, cellular telephone module, satellite module, or other IP embedded wireless communication modules. In some embodiments, the external device is traffic lights or other city infrastructure, a mobile device (such as a smart phone), wireless technology embedded in the vehicle itself, city wireless infrastructure including, for example, Wi-Fi networks, mesh networks, Low-Power Wide-Area Network (LPWAN) or Low-Power Network (LPN), or other proprietary wireless Internet of Things (IoT) networks.

### Digital Processing Device

In some embodiments, the methods, systems, and platforms described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian OS, Apple® iOS®, Research In Motion® BlackBerry OS®, Google® Android®, Microsoft® Windows Phone® OS, Microsoft® Windows Mobile OS, Linux®, and Palm WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

In some cases, the digital processing device is a server. In other cases, the digital processing device is a component of other devices, including, for example, an augmented reality parking device.

### Non-Transitory Computer Readable Storage Medium

In some embodiments, the methods, systems, and platforms disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the methods, systems, and platforms disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

Aspects disclosed herein provide AR applications configured to run on an AR parking device. In some embodiments, the AR parking device is configured to communicate via a computer network to a cloud back-end. The AR applications provide the user with an AR interface for identifying parking targets that are in need of parking maintenance or parking targets with parking enforcement citations. In some embodiments, the AR application comprises an interactive mode that enables the user to request more detailed information about maintenance warnings, tools or parts needed for a maintenance task, parking time for a single parking space, and/or parking citations for a specific area, including summary of parking citations for a specific area.

In various embodiments, the servers, the parking devices, methods, parking and systems, disclosed herein comprise at least one computer program, or use of the same. A computer program includes a sequence of instructions, executable in the computing device's CPU, written to perform a specified task. Computer readable instructions may be implemented as program modules, such as functions, objects, Application Programming Interfaces (APIs), data structures, and the like, that perform particular tasks or implement particular abstract data types. The computer program may be written in any suitable version of any suitable language. The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof. In some embodiments, a computer program includes the mobile application disclosed herein provided to an electronic device. In some embodiments, the mobile application is provided to the electronic device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

In aspects disclosed herein, the augmented reality (AR) applications are driven by an application computer program code using a mobile application development environment provided on an electronic device. In preferred embodiments, the electronic device comprises a smartphone, and the mobile application development environment comprises an SDK. In some embodiments, the electronic device is an AR parking device. Several aspects of the client code flow include, but are not limited to, the user experience (UX) constructs that provide the advantages disclosed herein. In some embodiments, the user exports data generated from any one of the above steps, or any combination thereof, to a cloud back-end to use for a project related to the space.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-In

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the methods, systems, and platforms disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Cloud Portal

The AR applications disclosed herein are configured to prompt a user to create a user account profile. Once the user account profile is complete, the user is prompted by the AR applications to describe the parking information overlay (e.g., the maintenance status overlay, the parking time overlay, and the parking citation overlay) the user wishes to view in the cloud portal. Next, the data is transmitted by the AR applications to the cloud portal via a custom API. In some embodiments, the cloud portal is configured to be the API EndPoint that receives the data. In various embodiments, the cloud portal configured to receive the data generated during the user's AR session is associated with the account of the user, the account of a recipient (e.g., meter/pay station maintenance providers, social media providers, insurance providers, enforcement agencies, municipal government agencies, federal government agencies, or towing companies), or a third party account. In some embodiments, a third party is an intermediate company employed to share limited amounts of user data with a recipient in situations when user or offender privacy is paramount.

The cloud portal is configured to provide a user via a user interface with a report comprising information related to the parking information overlay. Non-limiting examples of information related to the parking information overlay comprise a summary of maintenance tasks performed on specific single-space parking meter or multi-space parking station, expected cost associated with specific maintenance task, recommended meter/pay station maintenance providers, historical parking citation record for a driver or a vehicle of a specific license plate, the name of the user, current location of the user, and a viewer for images, videos and/or frames of a video taken by the user during the augmented reality (AR) session. In some embodiments, the information related to the parking information overlay is organized in modules that are configured to be individually collapsed and/or downloaded. The user interface enables the user to view and explore the parking information overlay using voice and/or touch gesture (e.g., selecting the parking meter/pay station for more detailed information, selection a section of a specific area for more detailed maintenance/parking citation information, selecting a member of the pay-by-parking space or pay-by-license plate grid, etc.). In some embodiments, touch gesture comprises touchscreen gesture, keyboard, mouse, or other gesture. Any suitable form of touch gesture may be implemented in the cloud portal for this purpose.

In some embodiments, the cloud portal is configured to assemble the uploaded data (e.g., user request, local maintenance status information received by the AR parking device, local parking time data received by the AR parking device, and local parking citation information received by the AR parking device) and transmit it via a computer network and an API to an alternate cloud platform using a data transmission system. In some embodiments, the data transmission system consists of data bundled in JSON format and transmitted via REST API. In some embodiments, the alternate cloud platform is a secondary cloud node within the original host network and/or a cloud node completely unaffiliated with the original network. In some embodiments, the original host network may be bypassed altogether and the data may be sent directly from the AR application to the alternate unaffiliated cloud node using. In some embodiments, the data is JSON encoded data, which is transmitted via REST API. In some embodiments, the alternate cloud node has the same rendering and analysis capabilities as the original cloud node. In some embodiments, the alternate cloud node does not have the same rendering analysis capabilities as the original cloud node. In further embodiments, the alternate cloud node is configured to repackage the data for subsequent use or further retransmission to yet other alternate cloud nodes. In a non-limiting example of a case in which security is of prime importance, the data is transmitted from the AR application to an alternate secure cloud node and the original cloud node can be accessed via API to help process the data without it ever leaving the secure environment.

In some embodiments, the report comprising information related to the parking information overlay is viewed by the user via a user interface, downloaded from the cloud portal, and/or shared with a recipient. Non-limiting examples of recipients include meter/pay station maintenance providers, social media providers, insurance providers, enforcement agencies, municipal government agencies, federal government agencies, or towing companies. In a non-limiting example, a user generates a parking citation report using the augmented reality (AR) applications disclosed herein of a parking vehicle that violated a parking regulation (e.g., purchased parking time expired 25 minutes ago), including time-stamped images of the parking vehicle taken during the AR session to submit a claim to a towing company or an enforcement agency. In this example, the images comprise metadata including the GPS coordinates and time stamp for every image taken during the AR session, thereby authenticating the user's claim. The AR applications convert all of the data and metadata generated during the AR session into a JSON format suitable for transmitting the data and metadata to the cloud portal. From the cloud portal, the user views a report comprising the data (e.g., parking citation overlay and images) and metadata (e.g., timestamp and GPS coordinates) on the cloud portal. The user shares the report to the towing company or the enforcement agency via a computer network. In addition, the user downloads the report for his or her records, and/or shares the report by printing the report and providing a copy of the report to the driver of the vehicle.

### Databases

In some embodiments, the methods, systems, and platforms disclosed herein include one or more databases, or use of the same. In view of the disclosure provided herein, those of skill in the art will recognize that many databases are suitable for storage and retrieval of user and parking information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. An augmented reality (AR) system for maintaining a plurality of parking meters using an AR maintenance application, the AR system comprising:
a) a server configured to:
i) receive data from the plurality of parking meters; and
ii) generate maintenance status information; and
b) a mobile device comprising:
i) a camera configured to capture a live view or a saved image of a real-world comprising at least one of the plurality of parking meters;
ii) a screen; and
iii) the AR maintenance application configured to:
A) control the camera to capture the live view or the saved image;
B) produce a maintenance status information layer comprising the maintenance status information of the at least one of the plurality of parking meters; and
C) overlay, on the screen, the maintenance status information layer on the live view or the saved image.

2. The AR system of claim 1, wherein the maintenance status information layer comprises a maintenance warning icon hovering around the at least one of the plurality of parking meters.

3. The AR system of claim 2, wherein the maintenance warning icon comprises a symbol indicating number of maintenance malfunctions for the at least one of the plurality of parking meters.

4. The AR system of claim 3, wherein the mobile device further comprises a control circuity configured to allow a user of the mobile device to interact with the mobile device.

5. The AR system of claim 4, wherein the control circuity is further configured to:
a) receive instructions from the user; and
b) display, on the screen, at least one malfunction icon indicating type of the malfunction of the at least one of the plurality of parking meters.

6. The AR system of claim 1, wherein the AR maintenance application is configured to update the maintenance status information in real-time.

7. The AR system of claim 1, wherein each of the plurality of parking meters is configured to communicate the maintenance information to the server, and wherein the maintenance information is stored in a parking meter database.

8. The AR system of claim 1, wherein the maintenance status information covers a specific area.

9. The AR system of claim 8, wherein the specific area is a street, a block, an intersection, a parking garage, or a neighborhood.

10. The AR system of claim 1, wherein the mobile device is further configured to interrogate the maintenance status information of the at least one of the plurality of parking meters.

11. The AR system of claim 1, wherein the maintenance status information comprises tools or parts required for each maintenance operation.

12. The AR system of claim 1, wherein the maintenance status information comprises an alert for a user of the mobile device to take or abandon each maintenance operation.

13. An augmented reality (AR) system for enforcing parking time at a plurality of parking meters using an AR parking time enforcement application, the AR system comprising:
a) a server configured to:
i) receive data from the plurality of parking meters; and
ii) generate parking time information; and
b) a mobile device comprising:
i) a camera configured to capture a live view or a saved image of a real-world comprising at least one of the plurality of parking meters;
ii) a screen; and
iii) the AR parking time enforcement application configured to:
A) control the camera to capture the live view or the saved image;
B) produce a parking time information layer comprising the parking time information of the at least one of the plurality of parking meters; and
C) overlay, on the screen, the parking time information layer on the live view or the saved image.

14. The AR system of claim 13, wherein the parking time information layer comprises an enforcement timer icon hovering around the at least one of the plurality of parking meters.

15. The AR system of claim 14, wherein the enforcement timer icon displays information of parking time for the at least one of the plurality of parking meters.

16. The AR system of claim 15, wherein the information of parking time is remaining parking time, time exceeding purchased parking time, remaining grace period after expiry of the purchased parking time, or an indication that the purchased parking time expired recently.

17. The AR system of claim 14, wherein the enforcement timer icon is color-coded for status of purchased parking time for the at least one of the plurality of parking meters.

18. The AR system of claim 13, wherein the at least one of the plurality of parking meters is a single-space parking meter.

19. The AR system of claim 13, wherein the AR parking time enforcement application is configured to update the parking time information in real-time.

20. The AR system of claim 13, wherein each of the plurality of parking meters is configured to communicate the parking time information to the server, and wherein the parking time information is stored in a parking meter database.

21. An augmented reality (AR) system for enforcing parking regulations at a plurality of parking meters using an AR parking regulation enforcement application, the AR system comprising:
a) a server configured to:
i) receive data from the plurality of parking meters; and
ii) generate parking citation information; and
b) a mobile device comprising:
i) a camera configured to capture a live view or a saved image of a real-world comprising a specific area, wherein the plurality of parking meters are located at or near the specific area;
ii) a screen; and
iii) the AR parking regulation enforcement application configured to:
A) control the camera to capture the live view or the saved image;
B) produce a parking citation information layer comprising the parking citation information of the plurality of parking meters; and
C) overlay, on the screen, the parking citation information layer on the live view or the saved image.

22. The AR system of claim 21, wherein the parking citation information layer comprises a first citation icon hovering at a first section of the specification area.

23. The AR system of claim 22, wherein the first citation icon comprises a symbol indicating number of parking citations for the first section of the specific area.

24. The AR system of claim 23, wherein the mobile device further comprises a control circuity configured to allow a user of the mobile device to interact with the mobile device.

25. The AR system of claim 21, wherein the live view or the saved image comprises a multi-space pay station in the specific area, wherein at least a fraction of the plurality of parking meters are managed by the multi-space pay station, and wherein the parking citation information layer comprises a first citation icon hovering at the multi-space pay station.

26. The AR system of claim 25, wherein the first citation icon comprises a symbol indicating number of parking citations for the fraction of the plurality of parking meters managed by the multi-space pay station.

27. The AR system of claim 26, wherein the mobile device further comprises a control circuity configured to allow a user of the mobile device to interact with the mobile device.

28. The AR system of claim 27, wherein the control circuity is further configured to:
a) receive instructions from the user; and
b) display, on the screen, detailed information of the parking citations for the fraction of the plurality of parking meters managed by the multi-space pay station.

29. The AR system of claim 28, wherein the detailed information of the parking citations is pay-by-parking space citations, wherein the overlay is a pay-by-parking space grid overlay, wherein each member of the grid represents a distinct single parking space, and wherein at least one member of the grid shows a parking citation.

30. The AR system of claim 29, wherein the control circuity is further configured to display, on the screen, detailed parking citation for the at least one member of the pay-by-parking space grid, the detailed parking citation comprising a parking space number and an enforcement timer for the distinct single parking space.

31. The AR system of claim 30, wherein the enforcement timer displays time passed since expiry of purchased parking time.

32. The AR system of claim 28, wherein the detailed information of the parking citations is pay-by-license plate citations, wherein the overlay is a pay-by-license plate grid overlay, wherein each member of the grid represents a distinct license plate, and wherein at least one member of the grid shows a parking citation.

33. The AR system of claim 32, wherein the control circuity is further configured to display, on the screen, detailed parking citation for the at least one member of the pay-by-license plate grid, the detailed parking citation comprising the distinct license plate and an enforcement timer for the distinct license plate.

34. The AR system of claim 33, wherein the enforcement timer displays time passed since expiry of purchased parking time.

35. The AR system of claim 21, wherein the AR parking regulation enforcement application is configured to update the parking citation information in real-time.

36. The AR system of claim 21, wherein each of the plurality of parking meters is configured to communicate the parking citation information to the server, and wherein the parking citation information is stored in a parking meter database.

37. The AR system of claim 21, wherein the specific area is a street, a block, an intersection, a parking garage, or a neighborhood.

38. The AR system of claim 21, wherein the mobile device is further configured to interrogate the parking citation information related to at least one of the plurality of parking meters.
